(19) United States
(12) Patent Application Publication
(10) Pub. No.: US 2009/0085879 A1
(43) Pub. Date: Apr. 2, 2009

(54) ELECTRONIC DEVICE HAVING RIGID INPUT SURFACE WITH PIEZOELECTRIC HAPTICS AND CORRESPONDING METHOD

(75) Inventors: Xunhu DAI, Gilbert, AZ (US); Robert Dodge Daverman, Chicago, IL (US); Mark William Oliver, Mundelein, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/864,156

(22) Filed: Sep. 28, 2007

(51) Int. Cl. G06F 3/041

(52) U.S. Cl. 345/173; 345/156

(57) ABSTRACT

An electronic device and corresponding method provide haptic feedback to a user. The electronic device includes a rigid input surface, a piezoelectric element directly attached to the rigid input surface, sensors disposed adjacent to the rigid input surface for sensing when the user selects various portions of the rigid input surface, the sensors providing electrical signals indicative of the selected portions, and a controller that receives the electrical signals from the sensors, and in response thereto causes drive signals to be provided to the piezoelectric element causing deformation of the piezoelectric element and bending of the rigid input surface, wherein the bending of the rigid input surface provides haptic feedback to the user in response to the user selecting of the rigid input surface.

### BACKGROUND OF THE INVENTION

1. Field of the Invention

The invention relates to an electronic device, and in particular, to an electronic device providing haptic feedback through a rigid input surface with a piezoelectric element.

2. Introduction

Electronic devices, such as cellular phones, handheld computers, MP3 players, and the like are very pervasive computing devices. The electronic devices provide various features, such as communications, computing features, Internet access, playing music or video, viewing images, etc. Such electronic devices will often include a display, such as an LCD (liquid crystal display).

New applications are being developed for such mobile computing electronic devices. Such mobile computing devices may include a large transparent glass lens or other rigid input surface that covers nearly the entire front face of the device. Under the glass lens may be a display area and a separate input area. The display area may display various images such as photos, video, text, and the like. The input area may include a keypad or other input items, and may be formed as a touch screen, for example.

Typically, such devices may include audio or visual feedback in the input area, such as a clicking sound or the display of a number corresponding to a pressed key. It would be advantageous if the input area could be provided with haptic feedback, such as through tactile sensations applied to the touch screen in the input area that a user can feel.

### SUMMARY OF THE INVENTION

An electronic device and corresponding method provide haptic feedback to a user. The electronic device includes a rigid input surface, a piezoelectric element directly attached to the rigid input surface, sensors disposed adjacent to the rigid input surface for sensing when the user selects various portions of the rigid input surface, the sensors providing electrical signals indicative of the selected portions, and a controller that receives the electrical signals from the sensors, and in response thereto causes drive signals to be provided to the piezoelectric element causing deformation of the piezoelectric element and bending of the rigid input surface, wherein the bending of the rigid input surface provides haptic feedback to the user in response to the user selecting of the rigid input surface.

### BRIEF DESCRIPTION OF THE DRAWINGS

In order to describe the manner in which advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary diagram of an electronic device in accordance with a possible embodiment of the invention;

FIG. 2 illustrates a block diagram of an exemplary electronic device in accordance with a possible embodiment of the invention;

FIG. 3 illustrates a diagram of an exemplary electronic device in accordance with a possible embodiment of the invention;

FIG. 4 is an diagram of an exemplary electronic device in accordance with a possible embodiment of the invention; and

FIG. 5 is a diagram of an exemplary electronic device in accordance with a possible embodiment of the invention

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without departing from the spirit and scope of the invention.

The invention comprises a variety of embodiments, such as a method and apparatus and other embodiments that relate to the basic concepts of the invention.

In a typical electronic device, an LCD display or other type of display is often used to display user interface information and visual content such as video, images, text, etc. For example, cellular phones, handheld computers and other mobile computing devices often come equipped with an LCD display. Many of these computing devices are equipped with a display including a glass lens where a user is able to view displayed items, and the user may also be allowed to perform input operations, such as through the use of a touch screen.

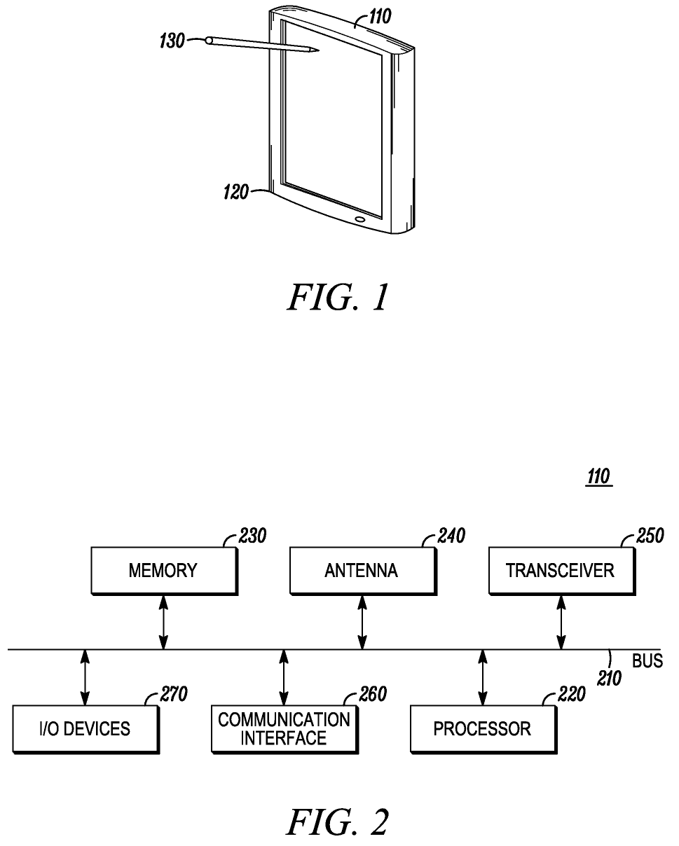

FIG. 1 illustrates an exemplary diagram of an electronic device 110 in accordance with a possible embodiment of the invention. The electronic device 110 may be any mobile or portable computing device, including a mobile telephone, cellular telephone, a wireless radio, a portable computer, a laptop, an MP3 player, satellite radio, satellite television, etc. The electronic device 110 may have a display 120, which may be a display such as an LCD display, for example. The electronic device 110 may include additional elements not shown herein.

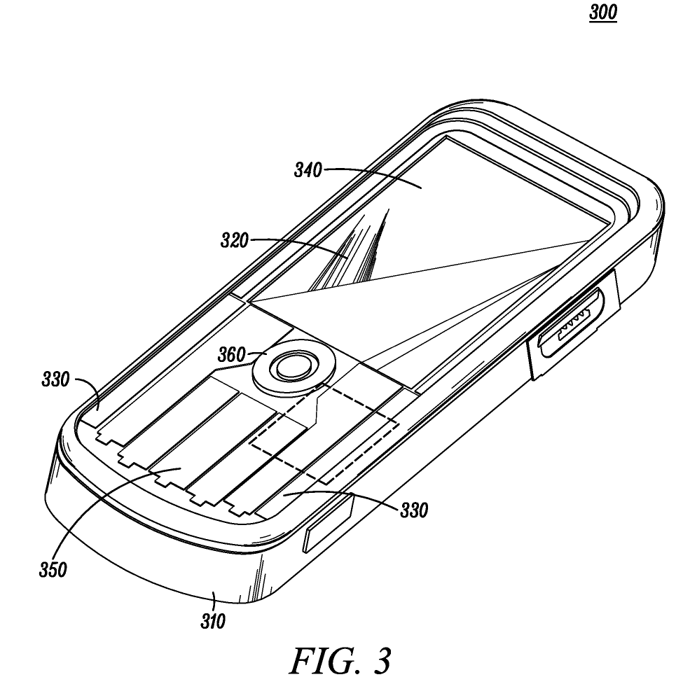

FIG. 2 illustrates a block diagram of an exemplary electronic device 110 in accordance with a possible embodiment of the invention. The exemplary mobile electronic 110 may include a communication bus 210, a processor 220, and a memory 230. The bus 210 may permit communication among the components of the electronic device 110. The electronic device 110 may include other optional elements such as an antenna 240, a transceiver 250, a communication interface 260, and input/output I/O) devices 270, although these elements may not be necessary to practice the invention.

Processor 220 may include at least one conventional processor or microprocessor that interprets and executes instructions. Memory 230 may be a random access memory (RAM or another type of dynamic storage device that stores information and instructions for execution by processor 220. Memory 230 may also include a read-only memory (ROM which may include a conventional ROM device or another type of static storage device that stores static information and instructions for processor 220.

Transceiver 240 may include one or more transmitters and receivers. The transceiver 240 may include sufficient functionality to interface with any network or communication station and may be defined by hardware or software in any manner known to one of skill in the art. The processor 220 is cooperatively operable with the transceiver 240 to support operations within the network.

Input/output devices I/O devices) may include one or more conventional input mechanisms that permit a user to input information to the mobile communication device 110, such as a microphone, touchpad, keypad, keyboard, mouse, pen, stylus, voice recognition device, buttons, etc. Output devices 270 may include one or more conventional mechanisms that output information to the user, including a display, one or more speakers, a storage medium, such as a memory, magnetic or optical disk, disk drive, and printer, etc., and/or interfaces for the above. The display may typically be an LCD display as used on many conventional mobile computing devices.

The invention will function with any input device with a hard input surface, such as a hard keypad surface, glass lens, and so forth, by adding haptic feedback. The programming necessary to accomplish this functionality of the invention may be stored in the memory of the mobile computing device at the time of manufacture, or may be loaded into the memory at a later time.

The electronic device 110 may perform functions in response to processor 220 by executing sequences of instructions or instruction sets contained in a computer-readable medium, such as, for example, memory 230. Such instructions may be read into memory 230 from another computer-readable medium, such as a storage device or from a separate device via a communication interface.

The electronic device 110 illustrated in FIGS. 1-2 and the related discussion are intended to provide a brief, general description of a suitable electronic device and processing environment in which the invention may be implemented. Although not required, the invention will be described, at least in part, in the general context of computer-executable instructions, such as program modules, being executed by the electronic device 110, such as a mobile telephone, or a television set-top box. Generally, program modules include routine programs, objects, components, data structures, etc. that perform particular tasks or implement particular abstract data types. Moreover, those skilled in the art will appreciate that other embodiments of the invention may be practiced in communication network environments with many types of communication equipment and computer system configurations, including cellular devices, mobile communication devices, personal computers, hand-held devices, multi-processor systems, microprocessor-based or programmable consumer electronics, and the like.

FIG. 3 illustrates an exemplary diagram of an electronic device 300 in accordance with a possible embodiment of the invention. The electronic device 300 may be one of various types of computing devices, such as a mobile phone, a personal data assistant, an mp3 player, and so forth. The electronic device may include an outer case 310, which may be metal or another material. The front face of the computing device may include a rigid input surface 320 or cover, such as may be present on an LCD or other type of display. The rigid input surface 320 may be glass, polycarbonate, crystal or another suitable material. The rigid input surface may also be transparent or semi-transparent, but such transparency is not needed to practice the invention.

The electronic device 300 may display various images to a user through the rigid input surface 320 by using conventional technologies. Additionally, the rigid input surface may be divided into two portions, a display portion 340 and an input portion 350. The display portion 340 may be used to display various images, such as text, photos, video, etc. The input portion 350 may allow the user to input various items, by use of a touch screen, for example. The touch screen may display various items for the user to select from, and the user may select desired items by touching the screen in the area where the items are displayed. In the central area of the rigid input surface 320 there may be a navigation device 360, which may act as an additional input device for the user.

In the input portion 350, there may be one or more piezoelectric element 330 directly attached to the rigid input surface 320. As further explained below, embodiments of the invention use the one or more piezoelectric element 330 to provide haptic (tactile) feedback to the user when the user is inputting items in the input portion 350, by selectively providing signals to the piezoelectric element 330 in response to the user providing input in the input portion 350. When the piezoelectric element 330 receives the signal, it changes shapes and bends the rigid input surface 320, causing a vibration in the rigid input surface 320 that may be felt by the user as haptic feedback.

As an example, the input portion 350 may display a keypad with sensors below each key in a conventional manner such as in many conventional cell phones. When the user presses on the rigid input surface in the input portion 350 above one of the displayed keys, the corresponding sensor senses the input, and a drive signal may be generated and sent to the piezoelectric element 330, causing bending and vibration in the rigid input surface 320, providing the desired haptic feedback to the user.

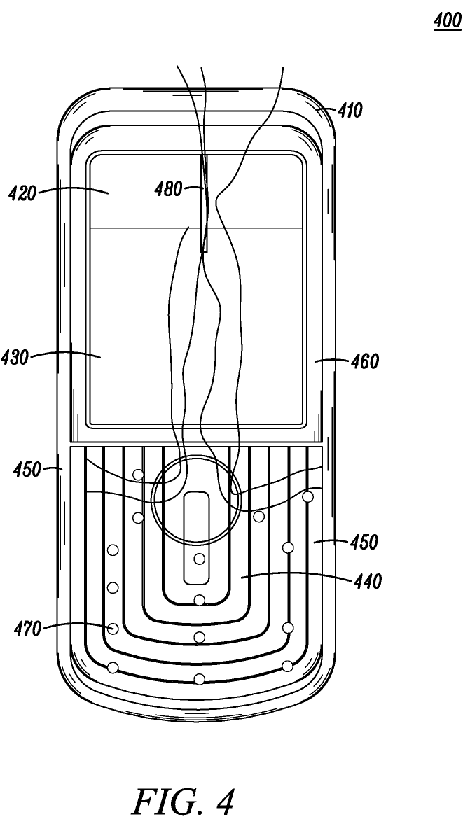

FIG. 4 illustrates an exemplary diagram of elements of an electronic device 400 in accordance with a possible embodiment of the invention. The electronic device 400 may include an outer case 410, which may be formed from metal, for example. Within the outer case 410 may be disposed a rigid input surface 420. The rigid input surface 420 may cover substantially all of the front face of the electronic device 400. The rigid input surface 420 may be divided into a display area 430 and an input area 440, although such a divided area is not necessary to practice the invention. Typically, the display area 430 will be used to display information to the user, such as text, photos, video, and so forth. The input area will typically be used to allow the user to input information, such as user selections to the electronic device 400.

One or more piezoelectric element 450 is attached to the rigid input surface 420. Typically, the piezoelectric element 450 is attached to a side edge of the rigid input surface 420, and in a preferred embodiment, two piezoelectric elements 450 may be used, with one attached to each opposing side edge of the rigid input surface 420. The piezoelectric element 450 may run along substantially an entire side of the rigid input surface 420, or along only a portion of the side. The piezoelectric element 450 may be directly attached to the rigid input surface 420, or may have one or more layer in between, as long as the layers allow sufficient bending of the rigid input surface 420 to provide the haptic feedback.

In embodiments, the piezoelectric element 450 may be attached to one or both sides of the input area 440 of the rigid input surface 420, while not being attached to the side portions in the display area 430, as shown in FIG. 4. This construction is used to provide haptic feedback in the input area 440, through bending of the rigid input surface via selective activation of the piezoelectric element 450. The display area 430 may be further isolated from the vibration of the rigid input surface 420 through the use of a gasket 450 bonded between a surface of the rigid input surface 420 and the metal frame 410. The gasket 450 may be an adhesive gasket, for example. The gasket 450 may additionally substantially surround the display area 430. The gasket may substantially isolate the outer case 410 from the haptic feedback.

Input from a user may be accomplished using conventional technology, such as the use of a touch screen that allows the user to touch the rigid input surface 420 in various areas to select from among a plurality of displayed inputs. For example, a keyboard or keypad may be displayed in the input area 440 using conventional technology, such as LCD technology, and the user may select various keys to input desired items, such as a phone number or text.

When the user touches the screen in the desired area, the user's touch is sensed by sensors 470. The sensors 470 send signals to a control or drive circuit, which may be used to generate drive signals to drive the one or more piezoelectric element 450 to provide haptic feedback to the user. The sensors 470 may be capacitive sensors, resistive sensors, optical sensors or other types of sensors that are able to sense the user touching or otherwise selecting various portions of the rigid input surface. The drive signals may be sent to the piezoelectric element 450 via wiring 480, for example.

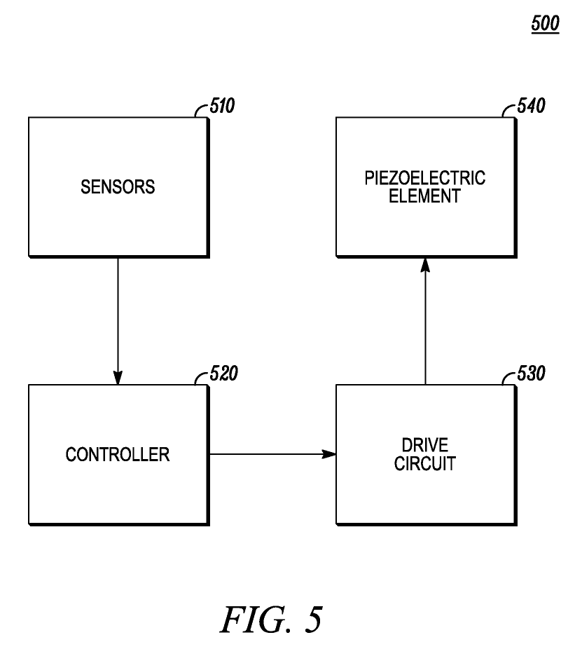

FIG. 5 illustrates an exemplary block diagram of an electronic device 500 according to possible embodiments of the invention. The electronic device includes sensors 510, corresponding to the sensors 470 of FIG. 4, that sense user input in an input area of the rigid input surface. Electronic signals indicative of the input to the sensors 510 are sent to controller 520, which may be a conventional controller such as a microprocessor, and the like. The controller 520 sends corresponding signals to drive circuit 530, which generates drive signals that are sent to and drive the piezoelectric element 540, and create the haptic feedback to the user by bending and vibrating the rigid input surface.

The rigid input surface 420 vibrates more at a center of the input area 440 than at the top or bottom of the display area 430. Thus, a user pressing a portion of the input area 440 near the center will experience more haptic feedback than when the user presses a portion of the input area 440 further from a center of the input area 440 if equal drive signals are applied to the piezoelectric element 450. Accordingly, embodiments of the invention may vary a magnitude and/or frequency of the drive signals dependent on a position on the input area 440 that is selected by the user to apply a more uniform haptic feedback to the user.

For example, if the input area 440 is displaying a standard telephone keypad with the numbers 1-9, *, 0 and # with 12 keys, the keys for the numbers 5 and 8 will generally be most centered while the other keys will be less centered, and so forth. If a user presses the input area 440 in the position of the 1 key, embodiments of the invention may apply a drive signal having a greater magnitude and/or frequency than if the user presses the input area 440 in the position of the 5 key or any other key less centered than the 1 key. Any number of different magnitudes of the drive signals may be used to provide a uniform haptic feedback regardless of the position the user presses.

An electronic device such as those illustrated herein may be formed by providing a rigid input surface, attaching a piezoelectric element to the rigid input surface, providing sensors disposed adjacent to the rigid input surface for sensing when the user selects various portions of the screen, the sensors providing electrical signals indicative of the selected portions, and providing a controller that receives the electrical signals from the sensors, and in response thereto causes drive signals to be provided to the piezoelectric element causing deformation of the piezoelectric element and bending of the rigid input surface, wherein the bending of the rigid input surface provides haptic feedback to the user.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. Accordingly, the appended claims and their legal equivalents should only define the invention, rather than any specific examples given.

We claim:

1. An electronic device providing haptic feedback to a user, comprising:
a rigid input surface;
a piezoelectric element attached to a side of the rigid input surface;
sensors disposed adjacent to the rigid input surface for sensing when the user selects various portions of the rigid input surface, the sensors providing electrical signals indicative of the touched portions; and
a controller that receives the electrical signals from the sensors, and in response thereto causes drive signals to be provided to the piezoelectric element causing deformation of the piezoelectric element and bending of the rigid input surface, wherein the bending of the rigid input surface provides haptic feedback to the user in response to the user selection of the rigid input surface.

2. The electronic device of claim 1, wherein the rigid input surface includes a display portion and an input portion, the piezoelectric element being disposed adjacent to the input portion.

3. The electronic device of claim 2, further comprising an adhesive gasket attached to the rigid input surface, the adhesive gasket being disposed at a boundary between the display portion and the input portion of the rigid input surface, wherein the adhesive gasket substantially isolates the display portion of the rigid input surface from the haptic feedback.

4. The electronic device of claim 3, wherein the adhesive gasket is disposed between the rigid input surface and an outer case of the electronic device, wherein the adhesive gasket substantially isolates the outer case from the haptic feedback.

5. The electronic device of claim 1, wherein the piezoelectric element is attached to the rigid input surface along an edge of the rigid input surface.

6. The electronic device of claim 5, wherein the piezoelectric element comprises two piezoelectric elements attached to opposite edges of the rigid input surface.

7. The electronic device of claim 1, wherein the drive signals provided to the piezoelectric element are varied dependent on a position in the input area of the rigid input surface touched by the user to provide a substantially uniform haptic feedback to the user.

8. The electronic device of claim 1, wherein the electronic device is one of a mobile telephone, a cellular telephone, a wireless radio, a portable computer, a laptop computer, an MP3 player, a remote control device, and a satellite radio.

9. A method of providing haptic feedback to a user of an electronic device, the electronic device having a rigid input surface, comprising:
sensing when the user selects various portions of the rigid input surface with sensors disposed adjacent to the rigid input surface, the sensors providing electrical signals indicative of the selected portions; and
driving a piezoelectric element attached to the rigid input surface based on the electrical signals provided by the sensors, the driving of the piezoelectric element causing deformation of the piezoelectric element and bending of the rigid input surface, wherein the bending of the rigid input surface provides haptic feedback to the user in response to the user selection of the rigid input surface.

10. The method of claim 9, wherein the rigid input surface includes a display portion and an input portion, the piezoelectric element being disposed adjacent to the input portion.

11. The method of claim 10, further comprising substantially isolating the display portion of the rigid input surface from the haptic feedback with an adhesive gasket attached to the rigid input surface, the adhesive gasket being disposed at a boundary between the display portion and the input portion of the rigid input surface.

12. The method of claim 19, further comprising substantially isolating an outer case of the electronic device from the haptic feedback with an adhesive gasket disposed between the rigid input surface and the outer case.

13. The method of claim 9, wherein the piezoelectric element is attached to the rigid input surface along an edge of the rigid input surface.

14. The method of claim 13, wherein the piezoelectric element comprises two piezoelectric elements attached to opposite edges of the rigid input surface.

15. The method of claim 9, wherein driving the piezoelectric element comprises varying drive signals applied to the piezoelectric element dependent on a position in the input area of the rigid input surface touched by the user to provide a substantially uniform haptic feedback to the user.

16. The method of claim 9, wherein the electronic device is one of a mobile telephone, a cellular telephone, a wireless radio, a portable computer, a laptop computer, an MP3 player, a remote control device, and a satellite radio.

17. A mobile computing device, comprising:
a rigid input surface;
a piezoelectric element attached to the rigid input surface;
sensors disposed adjacent to the rigid input surface for sensing when the user selects various portions of the rigid input surface, the sensors providing electrical signals indicative of the selected portions; and
a drive circuit that causes drive signals to be provided to the piezoelectric element in response to the electrical signals from the sensors, the drive signals causing deformation of the piezoelectric element and bending of the rigid input surface, wherein the bending of the rigid input surface provides haptic feedback to the user in response to the user selecting of the rigid input surface.

18. The mobile computing device of claim 17, wherein the rigid input surface includes a display portion and an input portion, the piezoelectric element being disposed adjacent to the input portion.

19. The mobile computing device of claim 17, further comprising an adhesive gasket attached to the rigid input surface, the adhesive gasket being disposed at a boundary between the display portion and the input portion of the rigid input surface, wherein the adhesive gasket substantially isolates the display portion of the rigid input surface from the haptic feedback.

20. The mobile computing device of claim 17, further comprising an adhesive gasket attached between the rigid input surface and an outer case of the electronic device, wherein the adhesive gasket substantially isolates the outer case from the haptic feedback.

21. The mobile computing device of claim 17, wherein the drive signals provided to the piezoelectric element are varied dependent on a position in the input area of the rigid input surface touched by the user to provide a substantially uniform haptic feedback to the user.

22. The mobile computing device of claim 17, wherein the mobile computing device is one of a mobile telephone, a cellular telephone, a wireless radio, a portable computer, a laptop computer, an MP3 player, a remote control device, and a satellite radio.
